(19) United States
(12) Patent Application Publication
(10) Pub. No.: US 2006/0261961 A1
(43) Pub. Date: Nov. 23, 2006

(54) Home monitoring system incorporating video

(76) Inventor: Lee D. Tice, Bartlett, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/131,499

(22) Filed: May 18, 2005

(51) Int. Cl. G08B 23/00

(52) U.S. Cl. 340/573.1

(57) ABSTRACT

Control circuitry is coupled to one or more local televisions. Programs or displays being presented on the televisions can be interrupted with displays or information from the control circuitry. Interrupting displays can include medication reminders, or indicators of a condition needing attention.

### FIELD OF THE INVENTION

The invention pertains to monitoring systems. More particularly, the invention pertains to such systems with video outputs displayable on television sets that also present locally available programming.

### BACKGROUND OF THE INVENTION

As the population of the United States ages, there is a continually increasing number of older individuals who are continuing to live at home or who have moved into assisted living arrangements. There are substantial social and economic advantages to supporting these individuals in maintaining their independent living status for as long as possible. In recognition of the fact that older individuals at times suffer from memory lapses, and/or have physiological conditions which need to be monitored, a variety of home monitoring systems have evolved over a period of time. One such system has been disclosed and claimed in U.S. patent application Ser. No. 10/956,681 entitled “A Mobile Telephonic Device and Base Station” filed Oct. 1, 2004 and assigned to the assignee hereof. The '681 application is hereby incorporated herein by reference.

The process of monitoring one or more physiological parameters associated with an individual, while useful, does not necessarily provide a follow up in connection with a need to take a variety of medications in accordance with a predetermined schedule. Nor does such monitoring necessarily provide simultaneous or alternate inputs to other individuals in the area via readily accessible display devices such as broadcast television.

Further, many known in-home monitoring systems incorporate a telephone or computer query of the resident in regards to their health status. This may include a series of questions that are answered by the person wherein their answers are transmitted to a remote monitoring location. The format for these queries can vary.

In these systems the person must respond to these queries to provide his/her status. A failure to respond as predicted can result in a follow-up call. A failure to respond to a follow-up call can result in a physical visit to check on the person. However, it is possible that the individuals are not responding because they are hard of hearing and did not know there was a query call or follow-up call because the entertainment system in their home has the volume turned up loud. This could result in an unnecessary and relatively expensive physical visit by a nurse or medical person. In addition, a family member may be trying to reach the individual and the failure to answer the telephone may worry the family member into contacting someone for a medical response to check on the person.

There thus, continues to be a need for monitoring systems and methods which could be used to provide prompts and follow ups in accordance with scheduled medications as well as alerting other individuals in the local area as to potential or developing problems via one or more local devices such as by local, residential television(s). In addition, there is a continuing need to facilitate responses by a resident to incoming wellness determining calls. Preferably, local display devices, such as residential televisions can be incorporated into systems or methods to inform a resident about such in-coming calls.

### BRIEF DESCRIPTION OF THE DRAWINGS

FIG. 1 is a block diagram of a system which embodies the invention;

FIG. 2 is a block diagram of another system which embodies the invention; and

FIG. 3 is a block diagram of yet another system which embodies the invention.

### DETAILED DESCRIPTION OF THE EMBODIMENTS

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Systems and methods which embody the invention overcome above-described problems by using a telephone or computer to interrupt an entertainment device when there is a pre-determined call coming into the home. This predetermined call could originate from a remote monitoring location for the further purpose of conducting a health/wellness query or from family or friends.

In one embodiment of the invention, a telephone is connected to an interface unit that can interrupt a cable line or antenna feed for a television, roster scan or other type of display or, entertainment unit since it is not limited to televisions. In this case, an incoming telephone call with an origination number that matches a predetermined list of telephone numbers will cause the interface unit to disconnect the cable or feed from the antenna, and, thus the signal to the entertainment unit.

The entertainment unit will lose the picture and have “static” sound until the telephone is answered. In some entertainment unit units, the entertainment unit will go quiet and the video blank (for example, a blue screen) and make it easier to hear the telephone.

In one embodiment, if the incoming telephone number is not on the list, it will not interfere with the signal to the entertainment unit. This also provides a prompt and signal to the resident that the telephone needs answering because it is from a person that may be involved with his/her health or has a relationship with the resident. Once the telephone has been answered, the cable connection and signal, or antenna feed can be re-established and the entertainment unit is then restored to normal operation.

In another embodiment, the interface could function such that it does not interrupt the entertainment unit or other entertainment device on the first call. If a phone is not answered the first time, the originator can call a second time within a predetermined time period.

The second call will trigger the interface to interrupt the cable and thus the signal to the entertainment unit. In this case, a unique order of calling is established. The use of a predetermined stored list of numbers in the interface may not be necessary. However, a pre-stored list could still be used to further screen incoming calls.

The interface can store numbers of the latest incoming calls and then match them with previous numbers of incoming calls to determine if a second call came in within the predetermined time period. The remote monitoring location, or relatives or friends would be aware of this feature and could use it to enhance the opportunity that the telephone will be answered by the resident.

Multiple entertainment units within the home can be controlled by the interface unit so that others within the home may also become aware of the pre-selected incoming calls and insure that they get answered. In addition to the entertainment unit, audio equipment in the home could also be controlled by the interface unit in a similar manner.

The multiple entertainment unit aspect of this invention can be very important when there are more than two occupants in the residence or home. Each individual can be alerted, or called, individually if they have different schedules. Both can be alerted, or called, so they can support each other in answering the phone. Otherwise, each of the persons could be behind closed doors watching or using their entertainment units. A house wide indication of an incoming telephone call can be indicated by interrupting multiple entertainment units.

In another embodiment, the interface unit could interrupt video or audio separately or alter the video or audio separately. In an example of altering the video, a screen-in screen display could indicate that there is an incoming call and show the telephone number of the originator of that call or other information to identify the caller.

It is within the scope of this invention to incorporate the function of the interface unit within the entertainment unit. If it is in the entertainment unit, then more complex functions can be realized. For example, the incoming call could result in an altered video or altered audio output from the entertainment unit.

It is also within the scope of this invention to provide stand alone systems that can be used without in-home monitoring systems. With this embodiment, family members will have an increased opportunity to have telephone calls answered by the hard of hearing without having to acquire a monitoring system. On the other hand, if desired, the interface could be coupled to a local system that monitors one or more conditions of the resident. If used as part of an in-home monitoring system, the interface unit could contain interfaces for the transfer of data from sensors used to measure physiological aspects of the patient.

It is also within the scope of this invention to attach a remote sounder to the output of the interface unit. The sounder could give an audio indication of an incoming call that matches a pre-determined telephone number. This remote sounder could be located such that it can be heard outside the home.

Where the resident has a computer that is capable of receiving messages that are timely such as with broadband and a continual connection, then the computer can replace the telephone. Thus a message from a pre-determined sender address can result in a signal being emitted by the computer and coupled to an interface unit that interrupts or alters the operation of the entertainment unit in any of the ways previously described.

The control of the entertainment units to indicate an incoming phone call can be accomplished in different methods. The previous method used an interface unit to actually interrupt the cable or wired signal to the entertainment unit.

Another method to control the entertainment unit, in accordance with the invention, is to use a remote control to alter the tuner settings of the entertainment unit when a telephone call is incoming and not yet answered, such as change TV channels. It is possible that the entertainment unit can be changed to a channel that receives a specific information message from the in-home monitoring system devices. Then video and/or audio information can be presented to the patient instructing them to answer the telephone. It may also provide information regarding the caller since caller ID technology is readily available.

Once the interface unit has channel control plus the ability to present video and audio information to the resident, many opportunities open up for the type of presentation. An audio message that repeats the name of the resident to wake him/her if sleeping can be provided along with audio or video instructions.

The use of the entertainment unit to alert the person to the incoming call can be effective because the alert is at least as loud as the setting of the entertainment unit and replaces the entertainment program being watched. This means that it cannot drown out the ringing of a telephone or other alert means.

In addition to answering the telephone, the entertainment unit can be interrupted in a similar manner to indicate that it is time to take prescribed medicines per a predetermined schedule. If there is a time range that the medications can be taken within, the in-home monitoring system can first provide a brief interruption of the entertainment unit and then period brief interruptions until the end of the said range.

At the end of the time range, the entertainment unit can be interrupted until the medications are taken. The taking of the medications can be monitored by the in-home monitoring system or indicated by a manual means. A report can be forwarded indicative of status of the medication taking process to a remote medical monitor via dial-up phone lines or wireless without limitation.

It will also be understood that references to “residential”, “home” or “in-home” or like words and phrases are intended to include not only house, home, apartments, condominium, townhouse type living arrangements, but also all types of assisted or sheltered living arrangements or configurations. The present systems and methods find applicability in all such circumstances. Further, “resident” refers to an individual or person living or staying at or in a respective living arrangement.

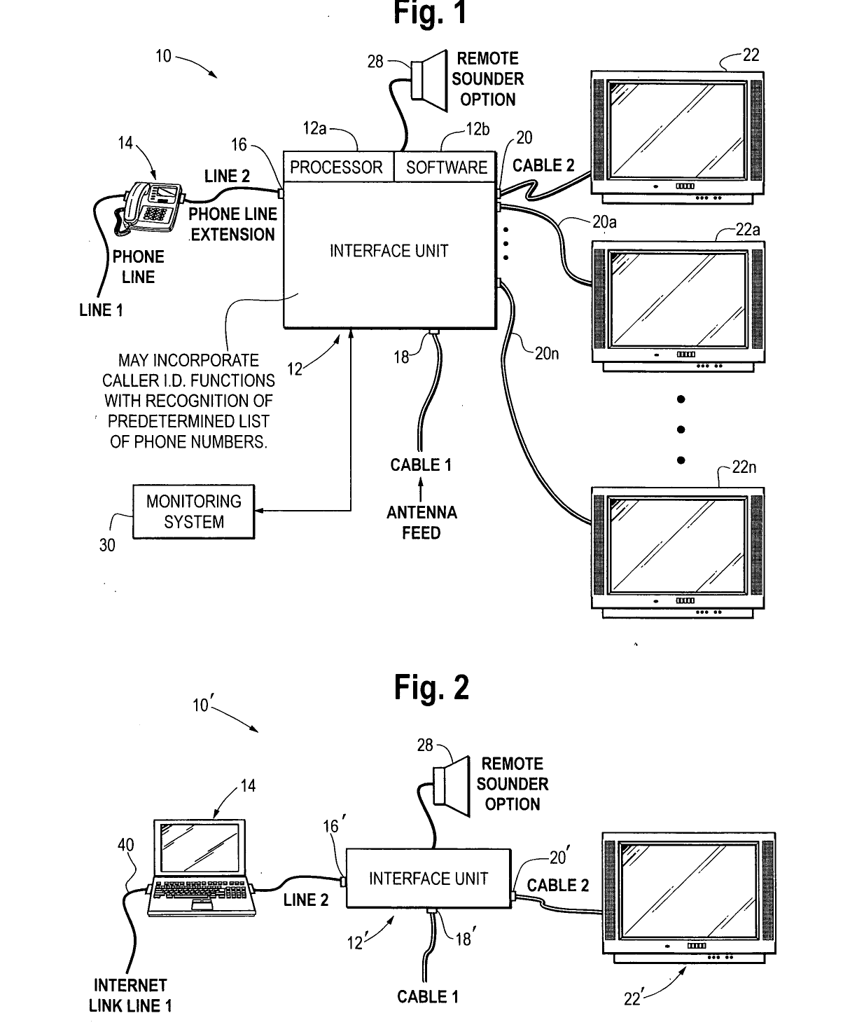

FIG. 1 is a block diagram of one embodiment of a system 10 in accordance with the invention. The system 10 incorporates an interface unit 12 which could be implemented in part with a programmable processor 12a and locally stored control software 12b. The interface unit 12, as described above, can be coupled on one hand to a wired telephone station (or wireless phone) set 14 which is capable of receiving incoming calls from a remote source as well as to a source of programming, which could be from a cable network or feed from an antenna via an input port 18. The output port 20 can be coupled to a raster scan display device 22, which could be a standard television set.

Those of skill will understand that the interface unit 12 could be coupled via one or more output ports 20a. . . 20n to a plurality of display devices 22a. . . 22n which might be located within a residence.

In one configuration of the system 10, the unit 22 can be located in a sitting room or bedroom of a resident. Another display device 22i could be located elsewhere in the residence or in the vicinity of a caregiver or relative of the resident.

During normal operation, feed from a cable network or antenna is coupled via input port 18 to one or more output ports 20, 20a. . . 20n to corresponding display devices 22, 22a. . . 22n. Normal programming is presented for the individual in the vicinity of the respective display device.

In the event that the incoming call to the telephone 14 is detected at the interface unit 12, the programming feed received at port 18 can be interrupted and a message presented via the display unit 22, 22a. . . 22n to the effect that an incoming call has been received for purposes of prompting the individual watching the programming on the display 22 to respond to the call at the telephone 14.

The unit 12 can be configured such that it incorporates a caller identification function and can recognize an origination number of the incoming call and compare it to a predetermined list of telephone numbers. A match will cause the unit 12 to interrupt the incoming programming and present either an audible or a visible message on the unit 22. Optionally, messages can be presented on additional display units located within the residential area 22a. . . 22n. It will be understood that the exact nature of the audible or visual prompt is not a limitation of the present invention. Where the element 14 is wireless, the unit 12 would include a wireless line thereto as would be understood by those of skill in the art.

Once the telephone 14 has been answered and responded to, the programming from the cable or antenna feed at input port 18 can be recoupled to the respective display units such as the unit 22. Where the element 14 is wireless, the unit 12 would include a wireless link thereto.

Those of skill will also understand that the control software 12b of the interface unit 12 can be configured to keep track of first and second incoming calls which occur within a predetermined time interval and originate from the same number. In this configuration the second incoming call will trigger the interface 12 to interrupt the incoming programming and signal the resident or other individuals in the area via the display unit 12 that two calls within a predetermined interval have arrived on the same origination number. This feature would be disabled in the event that the first call has been responded to via the telephone 14.

If desired, a displace audio output transducer 28 can be coupled to the interface unit 12 to provide a separate audio output with a message relating to the presence of an incoming call on the telephone 14. In this regard it would be understood that the unit 12 could incorporate digital signal processing circuitry for the purpose of formatting and creating a plurality of audible output messages for a resident either via the display unit 22 or the remote transducer 28.

It will also be understood that the system 10 can be coupled to receive inputs from or communicate to a monitoring system 30. The monitoring system 30 can monitor one or more physiological conditions of a resident who might be expected to be watching programming on the television or display unit 22. It will be understood that the exact details of a monitoring system 30, which could be implemented in accordance with application Ser. No. 10/956,681 incorporated herein, are not limitations of the present invention.

FIG. 2 illustrates an embodiment of a system 10′ in accordance with the invention. In the system 10′ incoming audio/video can be received via an Internet link 40 from a displaced server and presented at a local, or personal, computer 14′. A signal from the computer 14′ can be coupled via input port 16′ to interface unit 12′ for purposes of blocking or modifying incoming programming, via input port 18′, which is currently being displayed on unit 22′. The blocked or modified programming can be indicative of an incoming message to be reviewed at the computer 14′. Similar features can be provided in the system 10′ as discussed above relative to the system 10.

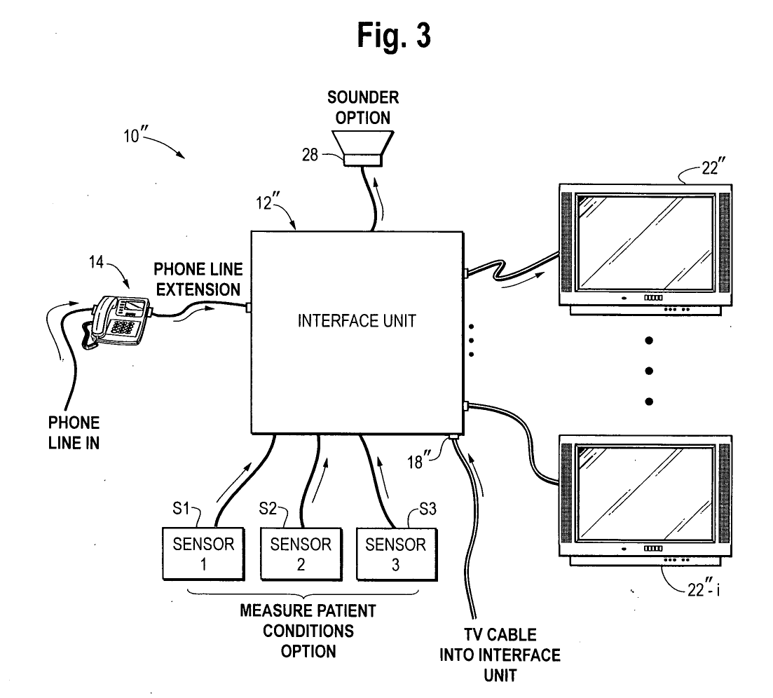

FIG. 3 illustrates yet another embodiment 10″ in accordance with the invention. In the system 10″ the interface unit 12″ can respond additionally to signals from one or more physiological sensors S1, S2 . . . Sn which are providing inputs pertaining to respective physiological parameters of the resident expected to be viewing incoming programming, port 18″ on a display 22″.

The resident can be prompted as to the existence of an incoming call on the telephone 14, by modifying the programming or presenting a message on the display 22″. In addition, the resident can be informed as to a variation in expected signal values or parameters associated with the sensors such as S1, S2 . . . Sn and could be prompted to take remedial/corrective action in connection therewith. In this regard, similar messages could be coupled to other displays in the immediate area which might be viewed by caregivers or other family members such as display 22″-i. All such displays are driven by output signals from the interface 12″.

In yet another embodiment, system 10″ can be used to follow-up on prescription medications in an associated schedule for the resident. One of the sensors, such as Si could be associated with a medication storage and dispensing container.

One or more messages can be overlaid on messages on the display 22″ prompting the resident to take a particular medication at a time in accordance with the schedule. The respective sensor Si provides feedback to the interface unit 12″ that the medication storage unit has been accessed by the resident for the purpose of acquiring and taking the required medication. It will be understood that messages associated with the above described functionality could be coupled to one or more additional display units 22″-i for the purpose of alerting other caregivers or family members in the area that the medication schedule indicates that one or more medications have been taken.

It will also be understood that both the system 10′ and the system 10″ could be used in conjunction with more extensive monitoring systems such as system 30 noted above, without departing from the spirit and scope of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. An apparatus comprising:
a monitoring system which provides information as to a condition of an individual in a region; and
a visual display to present pictorial programming available in the region, and including circuitry to couple information concerning the individual from the system to the display for presentation thereat.

2. An apparatus as in claim 1 where the circuitry includes one input for information signals from the monitoring system, a second input for programming signals and an output for coupling selected signals to the display.

3. An apparatus as in claim 2 where the circuitry includes an element that switches the signals from the one input and the second input.

4. An apparatus as in claim 1 including audio coupling circuitry which couples pre-determined audio indicia from the monitoring system to at least one audio output transducer for presentation.

5. An apparatus as in claim 4 where the graphical display includes the audio output transducer.

6. An apparatus as in claim 1 where the information coupled to the display comprises at least one of medication scheduling information, or, information that pertains to a physiological condition of the individual.

7. An apparatus as in claim 6 where the circuitry couples information concerning the individual to a different, displaced display.

8. An apparatus as in claim 7 where the display and the different display comprise raster scan display devices.

9. An apparatus as in claim 1 where the circuitry includes a manually settable input enabling a presentation of the information on the display irrespective of the presence of programming.

10. An apparatus as in claim 1 where the circuitry includes at least one of a temperature monitor, a cardiac monitor, a respiratory monitor, or a medication storage container monitor.

11. An apparatus as in claim 8 where at least one of audio or video information concerning the individual is presented to another individual.

12. A method comprising:
providing video-type programming;
presenting the programming to an individual;
monitoring an aspect of the individual's health; and
responsive to the monitoring, presenting at least one of visual or audible indicia indicative thereof to the individual.

13. A method as in claim 12 where the monitoring comprises following-up relative to a pre-determined medication schedule.

14. A method as in claim 13 where visually presenting includes presenting visual reminders to the individual that a medication should be taken.

15. A method as in claim 12 where the monitoring comprises monitoring at least one physiological condition of the individual.

16. A method as in claim 15 where the presenting includes presenting information as to the condition to at least one of the individual, or, another individual.

17. A method as in claim 16 where the presenting includes at least one of visually, or audibly presenting information as to the condition.

18. A method as in claim 17 where the monitoring comprises automatically following-up relative to a pre-determined medication schedule.

19. A method as in claim 13 where visually presenting includes presenting visual reminders to the individual that a medication should be taken.

20. A method as in claim 19 which includes monitoring a medication container for indicia indicative of at least an access thereof.

21. A method as in claim 20 which includes generating alerting indicia in the event of a lack of an expected access.

22. A method as in claim 21 which includes presenting the alerting indicia at least one of visually or audibly.

23. A method as in claim 12 which includes sensing an incoming communication, and modifying the presented programming to present an indicium indicative of the presence of the incoming communication.

24. A method as in claim 12 which includes sensing the presence of first and second communications from a common source and of modifying the presented programming to indicate the presence of the second of the two communications.

25. An in-residence monitoring system comprising:
at least one sensor for monitoring a condition of a person and an interface for transferring sensor data to another device;
at least one telephone;
at least one entertainment device which incorporates at least one of audio or visual outputs;
an interface device with at least one input for a telephone signal, a second input for information to be transferred to the at least one entertainment device, and at least one output to transferring information to the entertainment device; and
where the interface device does not output audio information to the entertainment device while the telephone is indicating an incoming call.

26. A system as in claim 25 where at least one entertainment device is a television.

27. A system as in claim 25 where at lest one entertainment device is a game playing device.

28. A system as in claim 25 where the interface device will output audio information to the at least one entertainment device when the telephone exhibits an off hook electrical state.

29. A system as in claim 25 where the interface device will alter information from the second input and transmit the altered information from the output to the at least one entertainment device.

30. A system as in claim 25 where the second input receives video or audio information, and the output transfers the video or audio information from the output to the entertainment device and wherein the interface does not output video information to the entertainment device when there is an incoming call on the telephone.

31. An in-residence monitoring system comprising:
at least one sensor for monitoring a condition of a person and an interface for transferring data to another device;
at least one duplex-type communications unit;
at least one entertainment device which responds to received audio and visual signals;
an interface device with at least a first input from the communications unit, at least a second input for audio and visual information, and an output to transfer the audio and visual information from the second input to the entertainment device; and
wherein the interface overrides at least entertainment video information and outputs an indication when there is an incoming call on the communications unit.

32. An in-residence monitoring system comprising:
at least one bidirectional communications device;
at least one entertainment device which provides at least one of audio or visual outputs;
an interface device with at least one input for a signal from the communications device, a separate input to receive one type of information to be transferred to the at least one entertainment device, and at least one output for the information to be transferred to the entertainment device; and
where the interface device does not output the one type of information to the entertainment device while the communications device is indicating an incoming communication that has an origination number present on a predefined list of origination numbers.

33. A system as in claim 32 where the predefined list is stored in the interface device.

34. A system comprising:
at least one bidirectional communications device;
at least one entertainment device incorporating audio and visual outputs;
an interface device with at least one input for a signal from the communications device, a separate input for one type of information to be transferred to the at least one entertainment device, and at least one output for the information to be transferred to the entertainment device; and
where the interface device does not output a representative of the signal to the entertainment device except where an incoming communication to the device originated from a common source as did a prior incoming communication to the device and both communications occurred within a predetermined period of time.

35. A system as in claim 34 where the source corresponds to an origination number.

36. A system as in claim 35 where the origination number is provided by a caller identification system.

37. A system as in 35 where prior incoming origination numbers are stored in the interface device.

38. A system comprising:
at least one sensor for monitoring a condition of a person and an interface for transferring sensor data to a receiving device;
circuitry for receiving incoming information from a remote location;
at least one entertainment unit which incorporates at least one of an audio or a visual output;
where the at least one audio or visual output is altered in response to incoming information.

39. A system as in claim 38 where the altering of at least one audio or visual output enhances a person's awareness and thus response to the incoming information.

40. A system as in claim 38 where the circuitry comprises a bidirectional communications device.
